(19) United States
(12) Patent Application Publication
(10) Pub. No.: US 2007/0100048 A1
(43) Pub. Date: May 3, 2007

(54) Composite dielectric film including polymer and pyrochlore ceramic and method of forming the same

(75) Inventors: II Doo Kim, Seoul (KR); Jae Min Hong, Seoul (KR); Ki Hong Park, Seoul (KR); Seung Hun Choi, Seoul (KR)

Correspondence Address: JONES DAY, 222 EAST 41ST ST, NEW YORK, NY, 10017, US

(73) Assignee: Korea Institute of Science & Technology, Seoul (KR)

(21) Appl. No.: 11/633,861

(22) Filed: Dec. 4, 2006

(30) Foreign Application Priority Data
Dec. 5, 2003 (KR) 10-2005-1174313

(51) Int. Cl. C04B 26/12

(52) U.S. Cl. 524/408

(57) ABSTRACT

The present invention provides a composite dielectric film including a polymer and a ceramic with pyrochlore structure and a method of fabricating the same. The composite dielectric film includes a polymer matrix and a ceramic of a pyrochlore structure filled in such polymer matrix.

The present application claims priority from Korean Patent Application No. 10-2005-0117413 filed on Dec. 5, 2005, the entire subject matter of which is incorporated herein by reference.

### BACKGROUND

1. Field of the Invention

The present invention generally relates to a polymer-ceramic composite dielectric, and more particularly to a composite dielectric film including a polymer and a ceramic with pyrochlore structure and a method of forming the same. The present invention further relates to a capacitor and transistor including such composite dielectric film.

2. Background of the Invention

The polymer-ceramic composite dielectric film is typically employed in an embedded capacitor or the like. The polymer-ceramic composite dielectric film includes dielectrics having a Perovskite structure such as BaTiO₃ (Barium Titanate), (Pb, Zr)TiO₃ (Lead Zirconium Titanate), PMN-PT (Lead Magnesium Niobate-Lead Titanate), etc. as a filler. The dielectrics with the Penroskite structure have a ferroelectric characteristic and a high dielectric constant ranging from 1,000 to 30,000. However, a high temperature sintering process at over 1300° C. should be carried out in order to form a Penroskite phase. Also, since its dielectric loss of the dielectrics with the Penroskite structure is high, it is difficult to be applied to electrical devices.

### BRIEF DESCRIPTION OF THE DRAWINGS

The present invention may be described in detail with reference to the following drawings in which like reference numerals refer to like elements.

FIG. 1 is a cross-sectional view showing a polymer-BZN composite dielectric film formed in accordance with one embodiment of the present invention.

FIG. 2 is a graph showing an intensity change of an X-ray diffraction pattern according to a BZN volume change in the polyimide-BZN composite dielectric film.

FIG. 3 is a graph showing changes of a dielectric constant and dielectric loss according to a BZN volume change in the polyimide-BZN composite dielectric film.

FIGS. 4A to 4C and FIGS. 5A to 5C are SEM photographs showing surface structures of the dielectric film according to a BZN ceramic volume change.

FIG. 6 is a graph showing an X-ray analysis result of an epoxy-BZN composite dielectric film.

FIG. 7 is a cross-sectional view of a capacitor including a polymer-pyrochlore ceramic composite dielectric film.

FIG. 8 is a graph showing dielectric loss of epoxy-BZN composite dielectric film as a function of frequency change measured in a capacitor structure in accordance with one embodiment of the present invention.

FIG. 9 is a perspective view of a transistor including a polymer-pyrochlore ceramic composite dielectric film as a gate insulator.

FIG. 10 is a graph showing a change in a dielectric constant of an epoxy-BZN composite dielectric film according to a frequency change.

### DETAILED DESCRIPTION

A detailed description may be provided with reference to the accompanying drawings. One of ordinary skill in the art may realize that the following description is illustrative only and is not in any way limiting. Other embodiments of the present invention may readily suggest themselves to such skilled persons having the benefit of this disclosure.

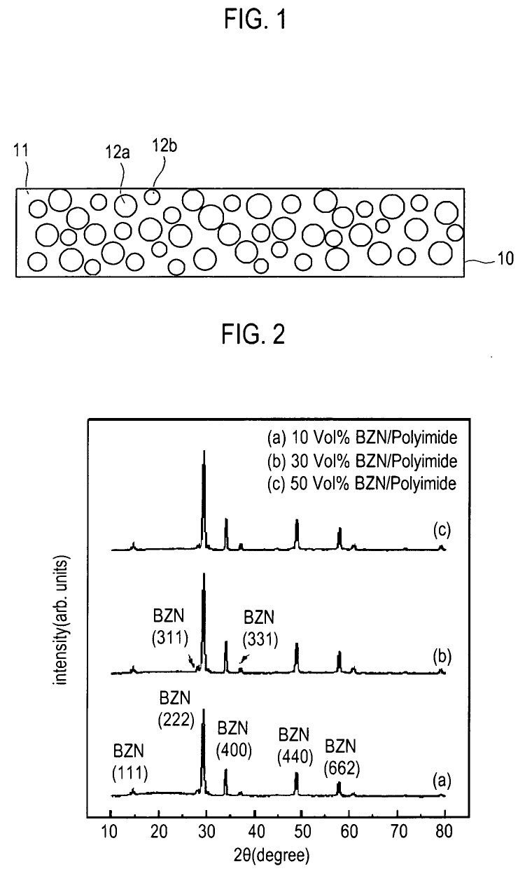

FIG. 1 is a cross-sectional view of a polymer-BZN dielectric film formed in accordance with one embodiment of the present invention. The reference numeral “11” represents a polymer matrix, while the reference numerals “12a” and “12b” represent the different sizes of BZN ceramic powders filled in the polymer matrix 11.

Hereinafter, a process for fabricating the polymer-BZN composite dielectric film will be described in accordance with one embodiment of the present invention.

First, a polymer matrix is provided by dissolving a polymer in an organic solvent. The polymer may be at least one of polyimide, epoxy, polyacrylate, polyethylene terephthalate and benzocyclobutene (BCB). DimethyLAcetamide (DMAc) may be used as an organic solvent. Polyamic acid may be used as a polymer matrix in accordance with one embodiment of the present invention.

A coupling agent is used for homogeneous dispersion of ceramic powder of a pyrochlore structure. The coupling agent is dissolved in water and ceramic powder of a pyrochlore structure is added into a flask. The mixture of the coupling agent and the ceramic powder are sonicated at a room temperature for about 10 minutes and stirred mechanically for 1 hour. And then the mixture is centrifuged. The obtained ceramic powder is subsequently washed by ethanol and dried in a vacuum oven in order to remove residual solvent. Then, a ceramic powder of a pyrochlore structure treated with the coupling agent is provided. The ceramic powder may be one of Bi₂(Zn_{1/3}Nb_{2/3})₂O₇, Bi_{1.5}ZnM_{1.5}O₇ (M=Nb, Ta, Sb), (Bi)₁₋ₓ(Zn,Nb,Ta,Ti)ₓO₇), (Ca, Ba, Sr, Pb)₁₋ₓ(Zn, Nb, Ta, Ti, Zr)ₓO and (Ca₁₋ₓSrₓ)Bi₄Ti₄O₁₅. The coupling agent is used to uniformly disperse the ceramic powder and may include INAAT (Isopropyltris N-aminoethyl-aminoethyl titanate) or 3-APTS (Aminopropyltriethoxy-silane) (Aldrich, 99%). In accordance with one embodiment of the present invention, Bi_{1.5}Zn_{1.0}Nb_{1.5}O₇ having a size of 5 nm to 10 μm, which is treated with a titanium-based coupling agent containing many functional groups, may be used as a ceramic powder.

Next, the ceramic powder of the pyrochlore structure, which is treated with the coupling agent, is dispersed into the polymer matrix to thereby form suspension. The ceramic powder of the pyrochlore structure used as a filler for filling the polymer matrix may include Bi₂(Zn_{1/3}Nb_{2/3})₂O₇, Bi_{1.5}ZnM_{1.5}O₇ (M=Nb, Ta, Sb), (Bi)₁₋ₓ(Zn,Nb,Ta,Ti)ₓO₇), (Ca, Ba, Sr, Pb)₁₋ₓ(Zn, Nb, Ta, Ti, Zr)ₓO or (Ca₁₋ₓSrₓ)Bi₄Ti₄O₁₅. Any combination of the elements within the parentheses may be allowed. A volume of the ceramic powder may be 1 to 90% of the volume of the polymer. Bi_{1.5}Zn_{1.0}Nb_{1.5}O₇ (BZN) having a size of 5 nm to 10 μm, which is treated with the coupling agent, may be used as a filler.

Subsequently, the suspension is coated on a substrate by using screen printing, spin coating or spray drying. Then, the suspension is imidized and hardened to thereby form a polymer-pyrochlore ceramic composite dielectric film. The polymer-pyrochlore ceramic composite dielectric film is baked at a relatively low temperature and formed by using a pyrochlore ceramic of low dielectric loss in accordance with one embodiment of the present invention.

For example, the BZN ceramic has merits in that it is easily formed in a pyrochlore phase at a relatively low sintering temperature of about 800° C. to 900° C., and that its bulk dielectric constant is of 210 to 230. Also, the BZN ceramic has a low dielectric loss of 5×10⁻⁴. Thus, the polymer-pyrochlore ceramic composite dielectric film formed in accordance with one embodiment of the present invention can be used in an electrical device using a high frequency.

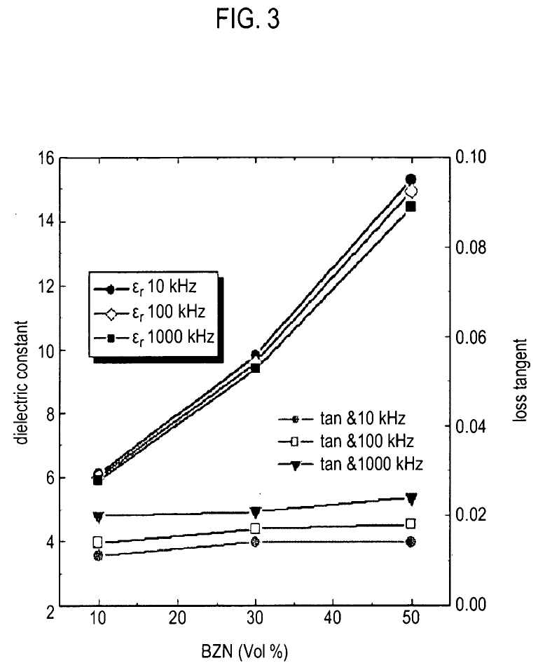

Hereinafter, the characteristic of the polymer-pyrochlore ceramic composite dielectric film will be described in detail. FIG. 2 provides graphs showing an intensity change of an X-ray diffraction pattern according to a BZN volume change in the polyimide-BZN ceramic composite dielectric film. The polymer-BZN ceramic composite dielectric film is formed by filling a polyimide matrix with a BZN (Bi_{1.5}Zn_{1.0}Nb_{1.5}O₇) ceramic powder of the pyrochlore structure. As the amount of the BZN filler is increased in the polyimide matrix, the X-ray intensity increases relatively. Thus, it can be indirectly known that the BZN ceramic powder of a single phase is uniformly dispersed in the polyimide matrix.

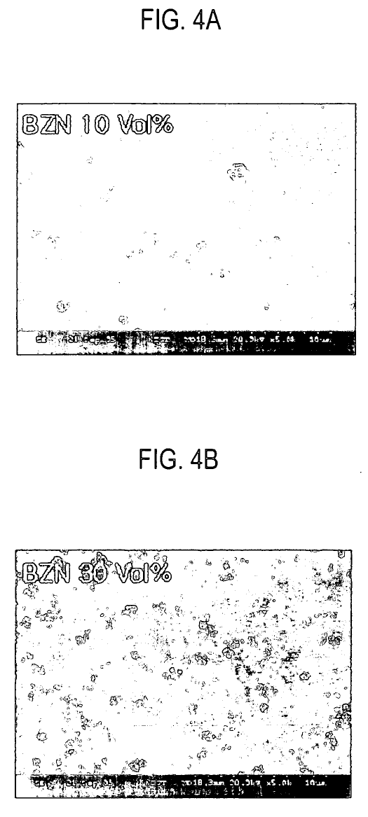

FIG. 3 provides a graph showing changes in a dielectric constant and dielectric loss according to a BZN ceramic volume change in the polyimide-BZN composite dielectric film. The behaviors of the dielectric constant and the dielectric loss according to a frequency change can be seen in FIG. 3. When the BZN volume is increased to 10, 30 and 50%, the dielectric constant is increased to 6, 10 and 14, respectively. On the other hand, when the frequency is changed to 10 KHz, 100 KHz and 1 MHz, the loss tangent is hardly changed. This means that the polyimide-BZN composite dielectric film rarely depends upon the frequency. That is, it can be known that the polyimide-BZN composite dielectric film has a stable frequency characteristic. Further, when the frequency is 1 MHz, the dielectric loss is less than 0.024, which is considered as a low dielectric loss.

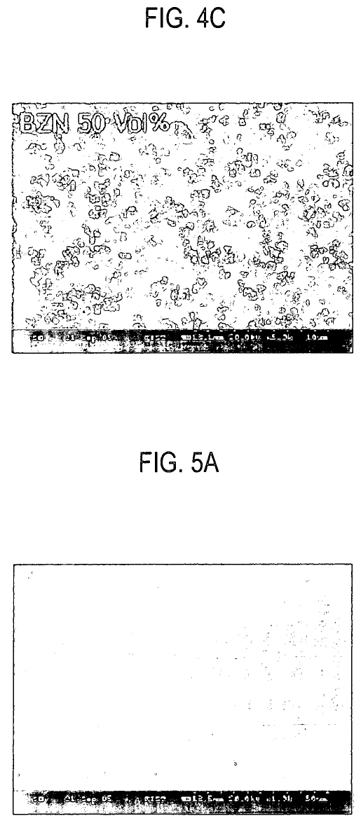

FIGS. 4A to 4C provide SEM photographs shoxving a surface structure of the dielectric film at a BZN ceramic volume of 10, 30 and 50% in the polyimide-BZN composite dielectric film, respectively. FIGS. 5A to 5C provide SEM photographs obtained through magnifying the photographs of FIGS. 4A to 4C by ⅕ times. As shown in FIGS. 4A and 5A illustrating the BZN ceramic volume of 10%, even if the BZN ceramic powder is a relatively small quantity, the BZN ceramic powder is dispersed without any lump of the ceramic powder in the polyimide matrix. Also, even if the BZN ceramic powder is a relatively large quantity, i.e., the BZN ceramic volume is of 50%, the BZN ceramic powder can be optimally dispersed as shown in FIGS. 4C and 5C.

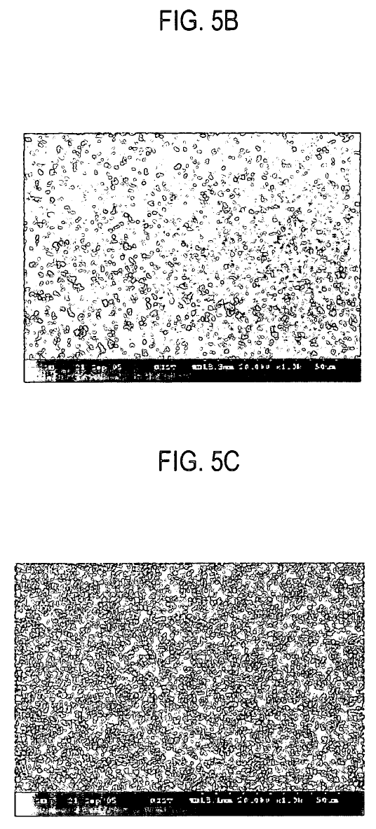

FIG. 6 provides a graph showing an X-ray analysis result of an epoxy-BZN composite dielectric film. The epoxy-BZN composite dielectric film is formed by spin-coating a composite dielectric film consisting of epoxy and a BZN ceramic powder of a volume of 50% on glass, on which indium tin oxide (ITO) is coated, at a thickness of 2 μm. As shown in FIG. 6, the BZN ceramic powder of a single phase can be optimally dispersed in the epoxy matrix.

As mentioned above, the polymer-pyrochlore ceramic composite dielectric film has a low dielectric loss characteristic. Thus, the polymer-pyrochlore ceramic composite dielectric film in accordance with one embodiment of the present invention may be variously utilized in a gate insulator of an organic thin film transistor and various thin film capacitors.

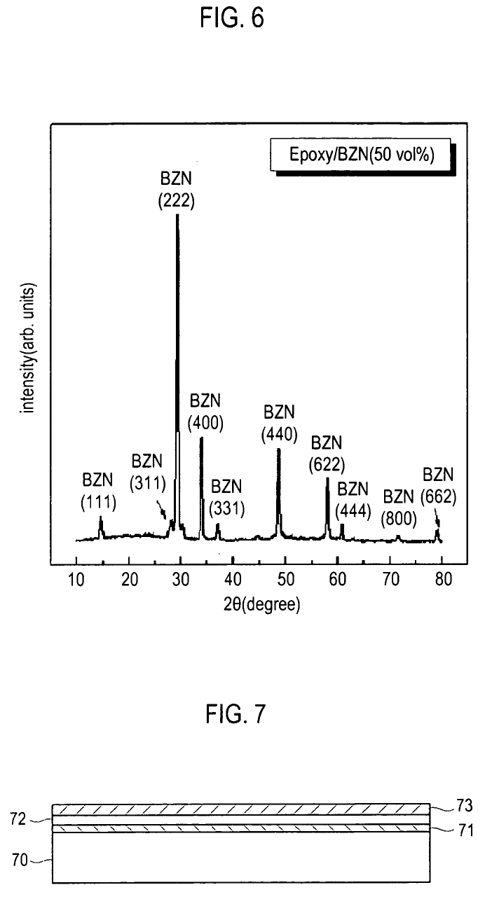

As shown in FIG. 7, a capacitor having the polymer-pyrochlore ceramic composite dielectric film includes a first electrode 71 formed on a substrate 70, a polymer-pyrochlore ceramic composite dielectric film 72 and a second electrode 73. The first electrode 71 is formed by depositing an ITO film on the glass substrate 70. The polymer-pyrochlore ceramic composite dielectric film 72 is formed by spin-coating epoxy/BZN (30 vol %) at a thickness of 3.5 μm on the first electrode 71. The second electrode 73 is formed in an Au film on the polymer-pyrochlore ceramic composite dielectric film 72.

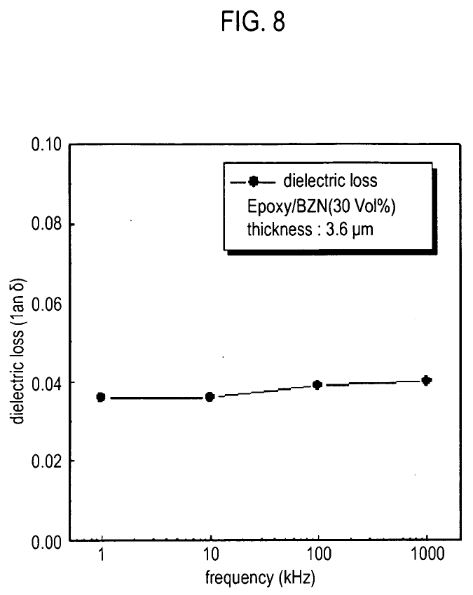

FIG. 8 provides a graph showing the dielectric loss measured in a capacitor, which is structured in accordance with one embodiment of the present invention. As shown in FIG. 8, the dielectric loss is changed to a range of 0.036 to 0.04 according to a frequency change. Specifically, in case the polyimide is used as a polymer in the polymer-pyrochlore ceramic composite dielectric film, the dielectric loss is about 0.02 at the capacitor structure.

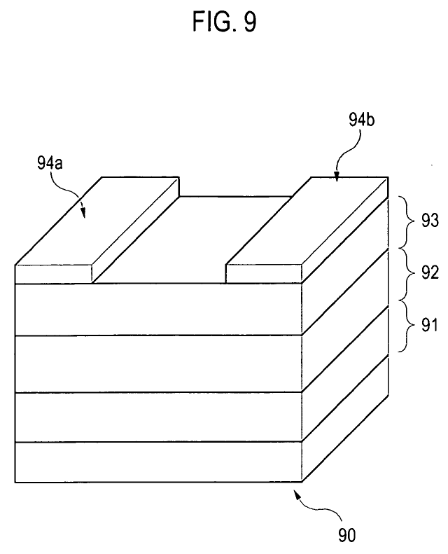

FIG. 9 is a perspective view of an organic thin film transistor including a polymer-pyrochlore ceramic composite dielectric film as a gate insulator thereof in accordance with one embodiment of the present invention. The organic thin film transistor includes a plastic substrate 90, a gate electrode 91, a gate dielectric film 91 formed with a polymer-pyrochlore ceramic composite dielectric film, a semiconductor film 93 and source and drain electrodes 94a and 94b. The plastic substrate 90 may be formed with polyimide, polyethylene terephtalate (PET), polyester sulfone (PES), polycarbonate (PC) or the like. The gate electrode 91 may be formed with one selected from the group consisting of Pt, Cr, Mo, Al, Au and Cu. The semiconductor film 93 may be an organic semiconductor film or an inorganic semiconductor. For example, the semiconductor film 93 may be formed by depositing pentancene and ZnO. The source and drain electrodes 94a and 94b may be formed in a metal film such as an Au film or the like.

The gate dielectric film 92 should have a low leakage current and a high dielectric constant. As the gate dielectric film 92 is formed with the polymer-pyrochlore ceramic composite dielectric film in accordance with an embodiment of the present invention, the characteristics of the leakage current and dielectric constant can be improved. That is, an excellent leakage current characteristic can be obtained from the polymer such as epoxy or polyimide forming the polymer-pyrochlore ceramic composite dielectric film. Also, a low dielectric constant (3 to 5) of the polymer is compensated by using the pyrochlore ceramic. Therefore, since the dielectric constant, which considerably affects the operating voltage of the transistor, is increased due to the use of the pyrochlore ceramic, the operating voltage of the transistor can be reduced.

In accordance with one embodiment of the present invention, since the gate dielectric layer is formed with suspension dispersing the pyrochlore ceramic powder having a size of less than 1 μm in the polymer matrix, surface roughness, which may otherwise cause by spin coating, may be reduced. It is preferable that the gate insulator 92 is formed with a thickness less than 5 μm to drive low voltage operating organic thin film transistor in accordance with one embodiment of the present invention.

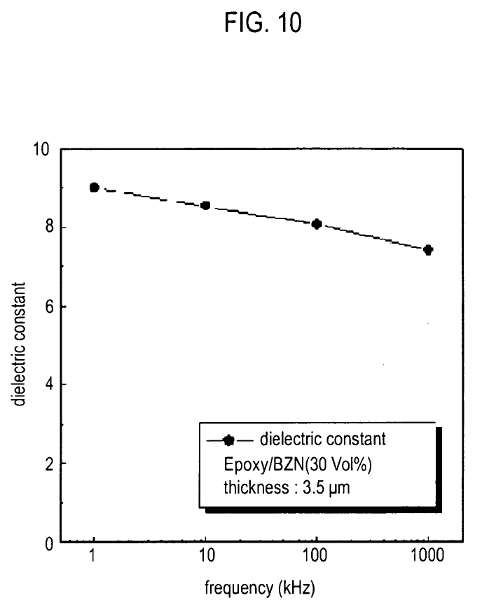

FIG. 10 provides a graph showing a change of a dielectric constant of an epoxy-BZN composite dielectric film according to a frequency change. As shown in FIG. 10, the dielectric constant of the epoxy-BZN composite dielectric film is changed from 9 to 7.41 as the frequency is changed from 1 kHz to 1 MHz. That is, the change of dielectric constant with the frequency change is not so significant

As mentioned above, as the polymer-pyrochlore ceramic composite dielectric film is used as a dielectric film, the dielectric constant can be increased and the dielectric loss can be reduced. The polymer-pyrochlore ceramic composite dielectric film formed in accordance with one embodiment of the present invention can be utilized in a dielectric film of the capacitor and a gate insulating layer of the transistor.

In accordance with one embodiment of the present invention, the composite dielectric film includes a polymer matrix and a ceramic of a pyrochlore structure filled in such polymer matrix.

In accordance with the present invention, there is provided a method of forming a composite dielectric film, including: dissolving a polymer in an organic solvent to provide a polymer matrix; providing a ceramic powder of a pyrochlore structure treated with a coupling agent; dispersing the ceramic powder of the pyrochlore structure in the polymer matrix to form suspension; providing a substrate; coating the suspension on the substrate; and performing thermal treatment for the substrate.

In accordance with another embodiment of the present invention, there is provided a capacitor including: a first electrode; a second electrode; and a dielectric film disposed between the first electrode and the second electrode. The dielectric film includes a polymer matrix and a ceramic of a pyrochlore structure filled in such polymer matrix.

In accordance with yet another embodiment of the present invention, there is provided a transistor including a semiconductor film; a gate electrode; and a gate insulating film disposed between the semiconductor film and the gate electrode. The gate insulating film includes a polymer matrix and a ceramic of a pyrochlore structure filled in such polymer matrix.

The polymer matrix is provided by dissolving a polymer in an organic solvent such as DMac (DimethylAcetamide).

It is preferable that the polymer has molecular weight and viscosity sufficient enough to coat a film on a substrate. Thermoplastics or thermosets may be used as the polymer in accordance with one embodiment of the present invention. For example, the polymer may be one selected from a group consisting of polyimide, epoxy, poly acrylate based material, phenol based materials such as PED and benzocyclobutane (BCB).

The ceramic powder of the pyrochlore structure used as a filler for filling the polymer matrix may be Bi₂(Zn_{1/3}Nb_{2/3})₂O₇, Bi_{1.5}ZnM_{1.5}O₇ (M=Nb, Ta, Sb), (Bi)₁₋ₓ(Zn, Nb, Ta, Ti)ₓO₇), (Ca, Ba, Sr, Pb)₁₋ₓ(Zn, Nb, Ta, Ti, Zr)ₓO or (Ca₁₋ₓSrₓ)Bi₄Ti₄O₁₅. Any combination of elements within the parentheses may be allowed. A volume of the ceramic powder may be 1 to 90% of a volume of the polymer. Bi_{1.5}Zn_{1.0}Nb_{1.5}O₇ (BZN) having a size of 5 nm to 10 μm, which is treated with the coupling agent, may be used as the filler. Various coupling agents may be used such as INAAT (Isopropyltris N-aminoethyl-aminoethyl titanate) or 3-APTS (Aminopropyltriethoxy-silane) (Aldrich, 99%).

Any reference in this specification to “one embodiment,” “an embodiment,” “example embodiment,” etc., means that a particular feature, structure or characteristic described in connection with the embodiment is included in at least one embodiment of the invention. Such phrases in various places in the specification are not necessarily all referring to the same embodiment. Further, when a particular feature, structure or characteristic is described in connection with any embodiment, it is within the purview of one skilled in the art to affect such feature, structure or characteristic in connection with other ones of the embodiments.

Although embodiments have been described with reference to a number of illustrative embodiments thereof, it should be understood that numerous other modifications and embodiments can be devised by those skilled in the art that fall within the spirit and scope of the principles of this disclosure. More particularly, numerous variations and modifications are possible in the component parts and/or arrangements of the subject combination arrangement within the scope of the disclosure, the drawings and the appended claims. In addition to the variations and modifications in the component parts and/or arrangements, alternative uses will also be apparent to those skilled in the art.

What is claimed is:

1. A composite dielectric layer, comprising:
a polymer matrix; and
a ceramic of a pyrochlore structure filled in the polymer matrix.

2. The composite dielectric layer of claim 1, wherein the polymer matrix is formed by dissolving a polymer into an organic solvent.

3. The composite dielectric layer of claim 2, wherein the polymer is at least one selected from the group consisting of polyimide, epoxy, poly acrylate, PED and benzocyclobutane (BCB).

4. The composite dielectric layer of claim 2, wherein the organic solvent is DMAc (DimethyLAcetamide).

5. The composite dielectric layer of claim 1, wherein the ceramic of the pyrochlore structure includes Bi₂(Zn_{1/3}Nb_{2/3})₂O₇, Bi_{1.5}ZnM_{1.5}O₇ (M=Nb, Ta, Sb), (Bi)₁₋ₓ(Zn, Nb, Ta, Ti)ₓO₇), (Ca, Ba, Sr, Pb)₁₋ₓ(Zn, Nb, Ta, Ti, Zr)ₓ_{O and (Ca}₁₋ₓSrₓ)Bi₄Ti₄O₁₅.

6. The composite dielectric layer of claim 2, wherein a volume of the ceramic is in a range of 1 to 90% of the polymer.

7. The composite dielectric layer of claim 5), wherein the ceramic powder of the pyrochlore structure is treated with a coupling agent.

8. A method of forming a composite dielectric film, comprising:
dissolving a polymer in an organic solvent to provide a polymer matrix;
providing a ceramic powder of a pyrochlore structure treated with a coupling agent;
dispersing the ceramic powder of the pyrochlore structure in the polymer matrix to form suspension;
providing a substrate;
coating the suspension on the substrate; and
performing thermal treatment for the substrate.

9. The method of claim 8, wherein the polymer is at least one selected from the group consisting of polyimide, epoxy, poly acrylate, PED and benzocyclobutane (BCB).

10. The method of claim 8, wherein the organic solvent is DMAc (DimethylAcetamide).

11. The method of claim 8, wherein the ceramic of the pyrochlore structure includes Bi₂(Zn_{1/3}Nb_{2/3})₂O₇, Bi_{1.5}ZnM_{1.5}O₇ (M=Nb, Ta, Sb), (Bi)₁₋ₓ(Zn,Nb,Ta,Ti)ₓO₇), (Ca, Ba, Sr, Pb)₁₋ₓ(Zn, Nb, Ta, Ti, Zr)ₓO and (Ca₁₋ₓSrₓ)Bi₄Ti₄O₁₅.

12. The method of claim 8, wherein a volume of the ceramic of the pyrochlore structure is in a range of 1 to 90% of the polymer.

13. The method of claim 8, wherein the coupling agent is one of INAAT (Isopropyltris N-aminoethyl-aminoethyl titanate) and 3-APTS (Aminopropyltriethoxy-silane).

14. A capacitor, comprising:
a first electrode;
a second electrode; and
a dielectric film disposed between the first and second electrodes;
wherein the dielectric film includes a polymer matrix and a ceramic of a pyrochlore structure filled in the polymer matrix.

15. A transistor, comprising:
a semiconductor film;
a gate electrode; and
a gate insulating film disposed between the semiconductor film and the gate electrode;
wherein the gate insulating film includes a polymer matrix and a ceramic of a pyrochlore structure filled in the polymer matrix.
